(19) United States
(12) Patent Application Publication
(10) Pub. No.: US 2024/0172851 A1
(43) Pub. Date: May 30, 2024

(54) Apparatus For Displaying Mobile Client Device

(71) Applicant: Samsung Electronics Co., Ltd., Suwon-si (KR)

(72) Inventors: Stefan van der Hoff, Mountain View, CA (US); Philipp Schoessler, Scotts Valley, CA (US); Daeeop Kim, Cupertino, CA (US); Hanna Fuhrmann, San Francisco, CA (US); Tara Sriram, Sunnyvale, CA (US); Curtis Aumiller, San Jose, CA (US); Cathy Kim, Palo Alto, CA (US); Jiawei Zhang, Sunnyvale, CA (US)

(21) Appl. No.: 18/378,868

(22) Filed: Oct. 11, 2023

Related U.S. Application Data
(60) Provisional application No. 63/429,089, filed on Nov. 30, 2022.

(51) Int. Cl. A45C 11/00; G09G 3/20; H04M 1/04

(52) U.S. Cl. CPC A45C 11/00; G09G 3/20; H04M 1/04; A45C 2011/002; A45C 2011/003; G09G 2340/0492; H04M 2250/12

(57) ABSTRACT

In one embodiment, an apparatus includes at least three sides forming an open enclosure, the at least three sides comprising a back side, a top, and a front side. The apparatus further includes a holder coupled to the inner surface of the back side and configured to secure a mobile client device to the apparatus. At least a portion of the front side opposite the holder includes a substantially transparent material.

### PRIORITY CLAIM

This application claims the benefit under 35 U.S.C. § 119 of U.S. Provisional Patent Application 63/429,089 filed Nov. 30, 2022.

### TECHNICAL FIELD

This application generally relates to an apparatus for displaying a mobile client device.

### BACKGROUND

Many consumer client electronic devices, such as smartphones, are used for a few to several years and are then replaced, e.g., by newer device models. Recycling options for consumer electronic devices are limited, and these options are, according to most studies, not often utilized. Used electronic devices often have defects relative to when those devices were new; for example, a used device may have scratches, a cracked screen, degraded battery life, non-functional buttons or other interactive elements (e.g. touchscreen), non-functional system components (e.g., a broken camera), and/or outdated hardware that is unable to sufficiently support newer software (e.g., newer operating systems).

### BRIEF DESCRIPTION OF THE DRAWINGS

FIG. 1 illustrates an example apparatus for holding a mobile client computing device.

FIG. 2 illustrates side views of the example apparatus of FIG. 1.

FIG. 3 illustrates example approaches for supporting a weight associated with the apparatus.

FIG. 4 illustrates another example apparatus for holding a mobile client computing device.

FIG. 5 illustrates an example in which stylized content is displayed on a display based on an orientation of the apparatus.

FIG. 6 illustrates an example layout for forming an example apparatus.

FIG. 7 illustrates an example step in the process of forming an example apparatus.

FIG. 8 illustrates an example computing system.

### DESCRIPTION OF EXAMPLE EMBODIMENTS

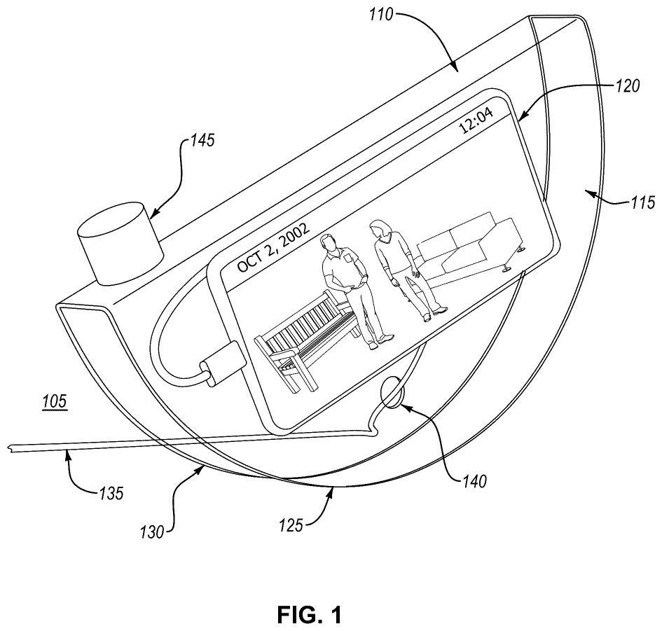

FIG. 1 illustrates an example apparatus for holding a mobile client computing device, such as a smartphone, a tablet, a smartwatch, etc. The example apparatus of FIG. 1 includes at least three sides forming an open enclosure, the at least three sides including a back side 105, a top 110, and a front side 115. The example apparatus of FIG. 1 includes a holder (not shown) that is coupled to the inner surface of back side 105 and configured to secure a mobile client device (device 120, in the example of FIG. 1) to the apparatus. As illustrated in the example of FIG. 1, the mobile client device is situated within the enclosure, between back side 105 and front side 115. At least a portion of the front side 115 opposite the holder includes a substantially transparent material, so that the mobile client device is at least partially visible through front side 115.

In the example of FIG. 1, edge 125 of the front side 115 (i.e., the edge opposite the top 110, as opposed to the edge at which the top 110 and the front side 115 meet) and edge 130 of the back side 105 are substantially rounded, permitting the apparatus to move rotationally on a surface supporting those edges, as described more fully herein. As the apparatus rotates, so too does the mobile client device, which is secured within the apparatus by a device holder.

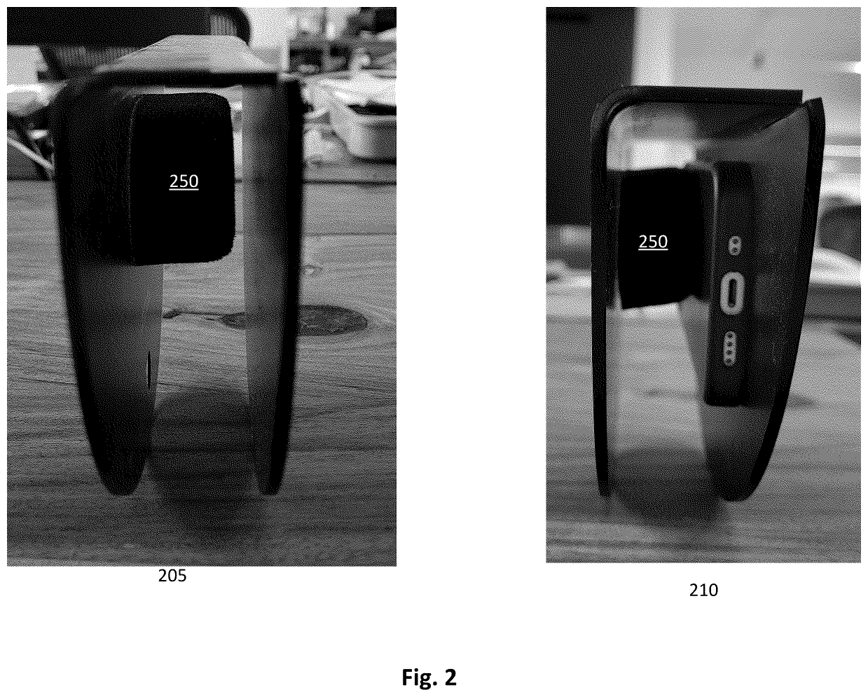

FIG. 2 illustrates side views of the example apparatus of FIG. 1. Side view 205 illustrates an example of holder 250, and side view 210 illustrates holder 250 holding a mobile device within the apparatus, similar to the example shown in FIG. 1. In particular embodiments, the holder may be a single piece of compressible material, such as a compressible foam, which may be used to hold the mobile device in place while a device cable (e.g. to power the device) can be freely positioned in the device (e.g., as illustrated by cable 135 in the example of FIG. 1). As illustrated in the example of FIG. 1, in particular embodiments an apparatus as described herein may include an opening 140 in the back side 105 of the apparatus, which permits, e.g., cabling to discreetly enter the enclosure.

This disclosure contemplates that a holder may be adhered to the apparatus's back side by any suitable means. For example, thin, clear double-stick tape may be used to secure the holder to the inner surface of the apparatus's back side. In particular embodiment, there may be a gap between the inner surface of the front side and the holder when no device is secured within the apparatus. This gap may be smaller than some, most, or all mobile devices so that, when a device is inserted into the open enclosure of the apparatus, the holder compresses the device against the inner surface of the front side, securing the device in place.

The back side, top, and front side of the apparatus may be made of any suitable material. In particular embodiments, these structures may be made of the same material. In particular embodiments, these structures may be made of different materials. In particular embodiments, at least a portion of the front side may be made of a substantially transparent material, so that at least some of the device can be viewed through the front side when the device is secured within the apparatus. For example, at least a portion of the front side may be made of one or more of a perforated material, a diffusive film, or a coated material. In particular embodiments, the apparatus may be made of an acrylic material or another plastic material, and the coated material on the front side may be a matte coating on the acrylic material. In particular embodiments, the matte coating may be applied (e.g., sprayed) on the inner surface of the front side (i.e., on the front-side surface facing the enclosure). In particular embodiments, at least a portion of the front side through which a mobile device can be viewed may be made of thinner material than the rest of the front side, increasing the transparency of the portion of the front side through which the mobile device can be viewed.

The portion of the front side through which the device is visible may not be completely transparent, for example to help reduce the visibility of scratches or other defects on the device, while still permitting a user to view the device through the front side of the apparatus. In particular embodiments, a front side of the apparatus may have a thickness of about 3 millimeters. In particular embodiments, the back side, top, and front side may all have the same or similar thickness.

In particular embodiments, an apparatus disclosed herein may include one or more moveable weights that adjust the center of mass of the apparatus, thereby causing the apparatus to rest at various orientations along its curved edge. For example, FIG. 1 illustrates a brass weight 145 that can be moved across the top 110 of the example apparatus, thereby adjusting the angle at which the apparatus rotates relative to the surface on which the apparatus rests. In particular embodiments, the bottom of a weight may include a material to prevent sliding of the weight, such as a rubber pad. In particular embodiments, the top surface of the top side may include a textured surface, for example to provide grip/friction to the weight and/or to provide a visual cue for placing the weight at different locations associated with different functionalities, as described more fully below.

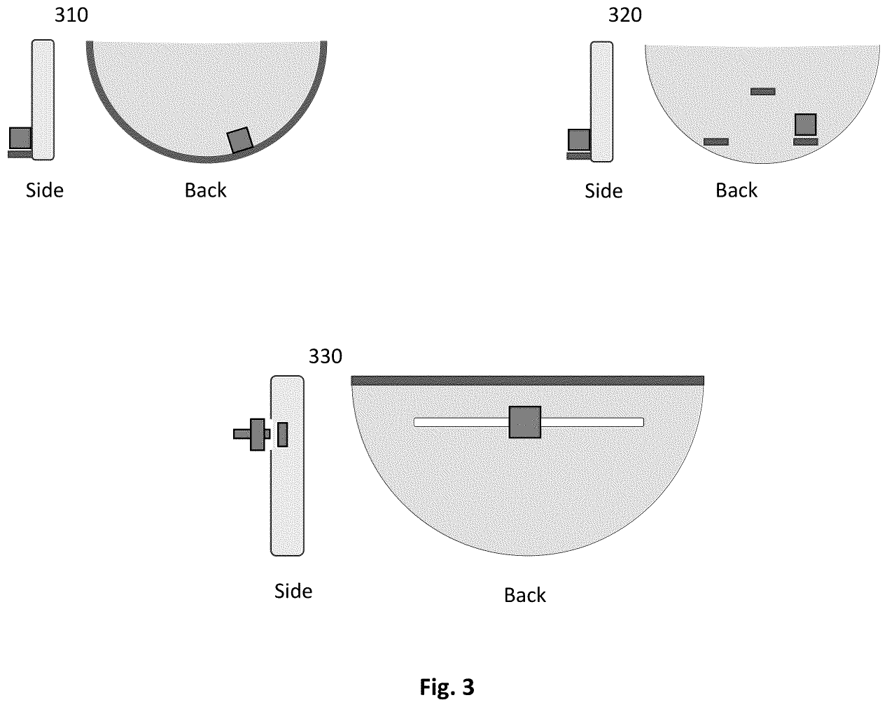

In particular embodiments, one or more shelves may be coupled to the back side of the apparatus to support a weight. For example, embodiment 310 of FIG. 3 illustrates an example in which a shelf follows the rounded contour of the edge of the back side. Embodiment 320 of FIG. 3 illustrates an example in which multiple protrusions, or shelves, extend from the back side, each protrusion associated with a different center-of-mass for the apparatus when the weight is placed on that protrusion. In particular embodiments, a track may be coupled to the apparatus, and the adjustable weight may be coupled to the track and configured to adjust along a length of the track, For example, embodiment 330 of FIG. 3 illustrates an example in which a track attaches to the back side of the apparatus, and the weight can slide along the track to adjust the center of mass of the apparatus. Although this disclosure describes various examples of ways to support or position a weight in order to adjust the center of mass of the apparatus, this disclosure contemplates that any suitable supports and positions may be used, and that particular embodiments may use two or more weights to adjust the center of mass. For example, particular embodiments may use direct attachments, such as Velcro, to attach a weight to the apparatus. As another example, particular embodiments may use one or more magnets (e.g., positioned around the apparatus) to affix a weight to the apparatus.

In particular embodiment, a base may support the apparatus (e.g., the example apparatus of FIG. 1), and the base may rock the apparatus, e.g., by oscillating from side to side, in a direction parallel to the long side of the top. In particular embodiments, an apparatus may include a pendulum disposed within the apparatus that is operable to rock the apparatus by oscillating.

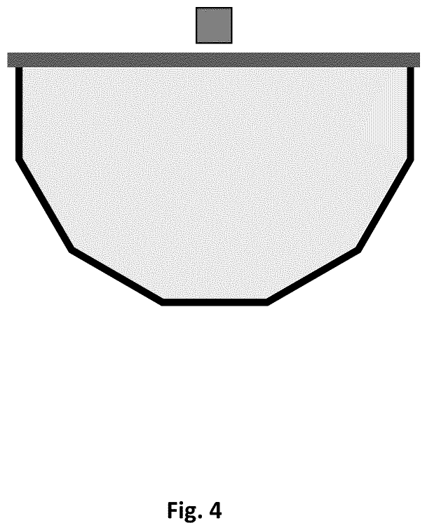

While the example of FIG. 1 illustrates an apparatus that forms a substantially half hemispherical shape, this disclosure contemplates that other shapes may be used. For instance, FIG. 4 illustrates an example of a substantially rounded apparatus that includes substantially linear edge segments connected to form a substantially rounded shape.

As illustrated in the example of FIG. 1, a client device secured to the apparatus exhibits the same motion and orientation as the apparatus. Therefore, one or more sensors in the client device (e.g., an accelerometer, a gyroscope, an IMU, etc.) can detect this motion or orientation (or both) to provide certain functionality, e.g., to control the display of content on a display of the client device.

For example, a method of determining content for display based on the orientation of the apparatus may include detecting, by the mobile client device, an orientation of an apparatus holding the mobile client device. The client device may detect the orientation using one or more of the device's sensors, as discussed above. The example method of determining content for display based on the orientation of the apparatus may further include determining, based on the detected orientation, content for display on a display of the mobile client device. For example, as discussed more fully herein, an apparatus's orientation may be adjusted or selected by adjusting the center of mass of the apparatus or by rocking or tilting the apparatus, and these changes in orientation may control what content is displayed on a display of the device, as well as how that content is displayed. In particular embodiments, the orientation or motion (or both) of the apparatus may be detected and used by the device to control device functionality (e.g., to control music or sounds played by the device). In particular embodiments, a sensed orientation (e.g., angle) of the apparatus can be applied as a discrete or continuous parameter to control device functionality (e.g., to control content displayed on the device).

As an example of controlling content displayed on a device, particular embodiments may access a photo library (or other display-media library) and select the content to display based on the device orientation. For example, a specific orientation (or range of orientations) of the apparatus may correspond to a particular photo from a photo library. In particular embodiments, the correspondence may be predictable, i.e., a particular photo may correspond to a particular orientation, and that correspondence does not change over time (unless the photo is deleted). In particular embodiments, the correspondence may be randomly determined. In particular embodiments, moving the device (e.g., rocking the device or tilting the device) may select a different media content to display on the device. For example, rocking the device may select a new photo to display each time the apparatus completes a rocking cycle.

As another example of controlling content displayed on a device, particular embodiments may update one or more effects added to content on the display based on the device orientation. For example, the device may display a clock face, and the typography used to display the clock face (e.g., clock digits) may be changed each time the device completes a rocking cycle. In particular embodiments, the effects may be changed in a random order, so that different effect sequences occur with different rocking sequences.

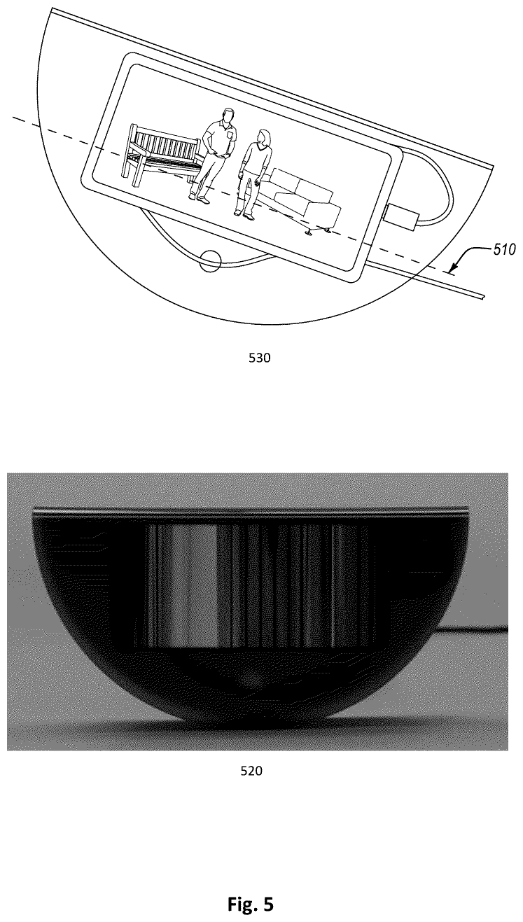

As another example of controlling content displayed on a device, particular embodiments may adjust an amount of effect applied to content displayed on a display, based on the detected orientation of the apparatus. For example, a portion of an image displayed on a display may be stretched or otherwise modified so that a stylized image appears on the display, and the amount of stretching may be based on the apparatus orientation. For example, FIG. 5 illustrates an example in which stylized content is displayed on a display by stretching a portion of an image (e.g., the pixels crossing line 510) in a particular direction (e.g., in a direction perpendicular to line 510) to fill the display. The resulting stylized image is shown in frame 520, and an example original image is shown in frame 530. The degree or amount of applied stretching effect may vary between the untilted angle shown in frame 520 (maximum stretch) and the titled angle shown in frame 530 (minimum stretch revealing the original image).

In particular embodiments, different display modes may be selected by tilting the apparatus, as sensed by an attached client device. For example, a user may select between a clock mode that displays a clock face and a photo mode or video mode that displays photos or videos by tilting the apparatus, e.g., about an axis passing through the top surface and the open enclosure.

While the discussion above provides specific examples of content and effects that vary based on apparatus orientation, this disclosure contemplates that any suitable content or effects may vary based on device orientation. For example, a camera on the client device may be used to create rocking kaleidoscope imagery/art captures. As another example, rocking the apparatus may be used to silence an alarm, while locating the weight in a specific location may turn off the alarm, or may snooze the alarm for a preset amount of time (e.g., 1, 5, or 10 minutes) based on the locating of the weight in a specific corresponding location. In particular embodiments, one or more visual animations may display on the device to visualize time. For example, a large crashing wave may slow to a calm, rocking motion. In contrast, small amounts of fireworks may slowly build up to a large display of many fireworks going off at once when the alarm goes off.

As another example, a brightness of the display may be changed or selected by rocking the display and/or by locating the weight in a particular location. As another example, rocking motion may be used to introduce random rolls of dice in a game, and the weight may be used to introduce variability in the outcome of a game or event (e.g., by splitting a deck in a location indicated by the center-of-mass, as controlled by the weight). As another example, the orientation of the apparatus may be used as a volume control when the device is playing sounds, such as music. As another example, the device may send a notification or chime to a connected device (e.g., a device associated with a contact) by rocking the apparatus.

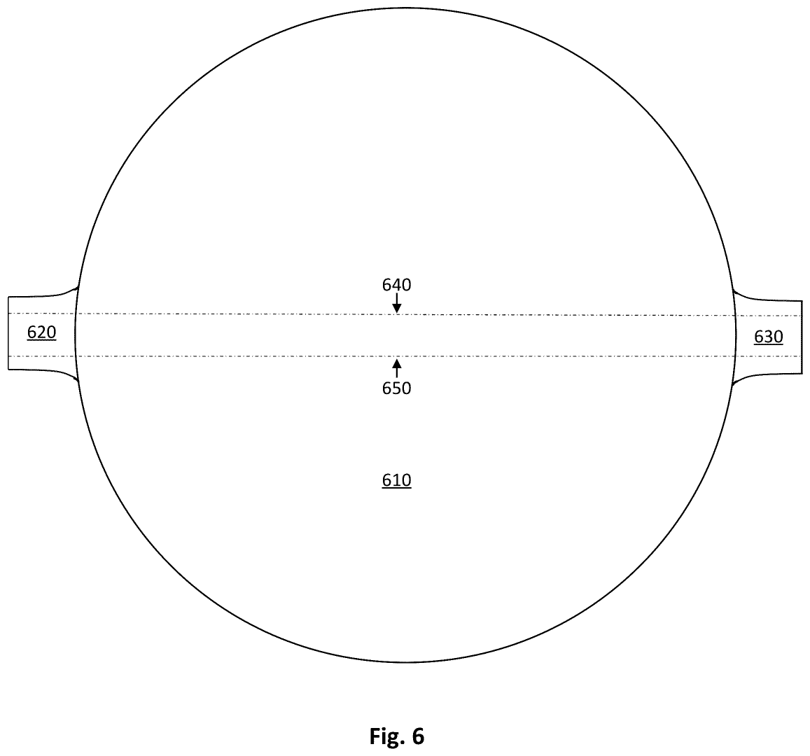

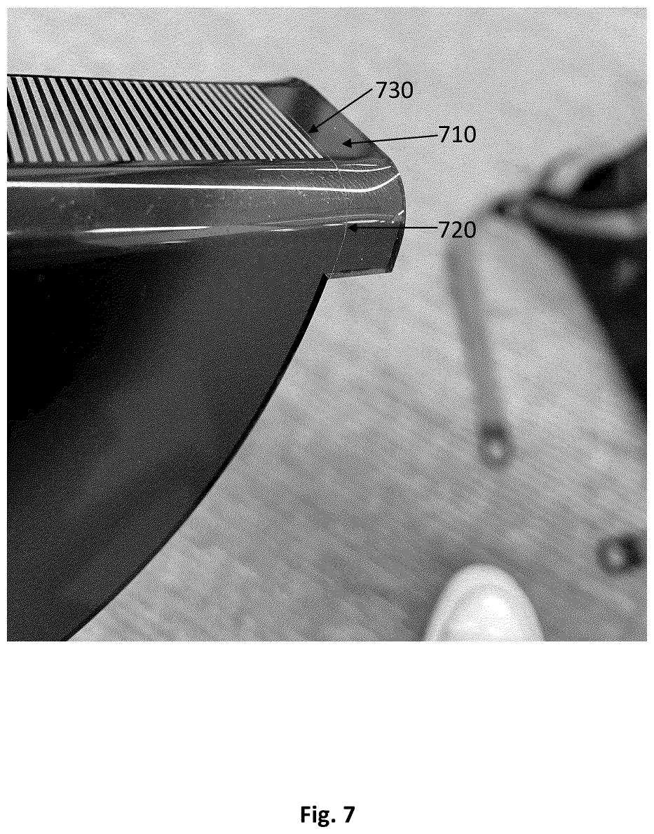

In particular embodiments, an apparatus may be formed by folding a single sheet of, e.g., acrylic, until the final form of the apparatus is obtained, e.g., the form shown in the example of FIG. 1. In particular embodiments, a method of manufacturing an apparatus may include forming a sheet of acrylic. As illustrated in the example of FIG. 6, the sheet may include a substantially circular portion 610 and may include excess material, which includes (1) at least part of a first protrusion 620 formed at a first edge of the circular portion, and at least part of a second protrusion 630 formed at a second edge of the circular portion. In the example of FIG. 6, the first protrusion 620 and the second protrusion 630 are diametrically opposite each other. The manufacturing method may further include bending the acrylic sheet along a first segment 640 and along a second segment 650, where the first and second segments each extend along a portion of the first protrusion and a portion of the second protrusion, for example as shown in FIG. 6. In the example of FIG. 6, after bending the sheet of acrylic has three sides (a back side, a top, and a front side) that form an open enclosure, for example as shown in the example of FIG. 1. The manufacturing method includes removing, after bending the acrylic sheet, the excess material (here, at least a section of the first protrusion and at least a section of the second protrusion) so that each edge of the top is substantially flush with an adjoining edge of the front side and an adjoining edge of the back side. For example, FIG. 7 illustrates that curved section 710 (which corresponds to protrusion 630) should be removed from the bent acrylic sheet so that edge 720 is flush with edge 730, after section 710 is removed (e.g., as shown in the profile of the example of FIG. 1).

The material may be removed by sanding, by laser etching, by machining, by flame polishing, or by any other suitable technique or combination of techniques. While the examples in FIGS. 6 and 7 describe a particular approach to forming the apparatus illustrated in, e.g., FIG. 1, this disclosure contemplates that any suitable approach may be used. For example, gluing or welding techniques (or any other suitable technique) may be used to connect pieces of a material into the form illustrated in, e.g., FIG. 1.

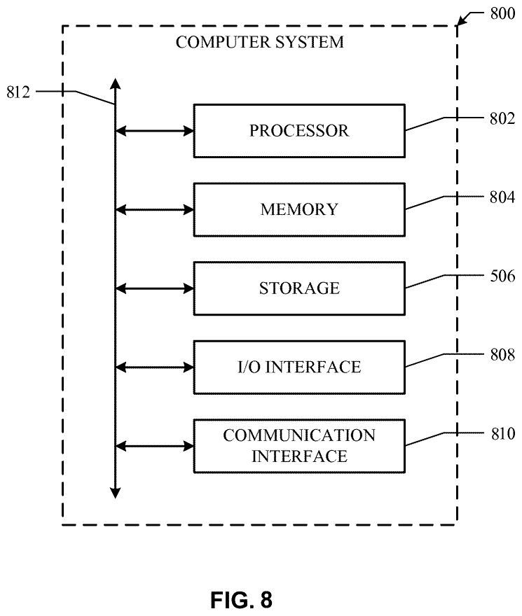

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. An apparatus comprising:
at least three sides forming an open enclosure, the at least three sides comprising a back side, a top, and a front side; and
a holder coupled to the inner surface of the back side and configured to secure a mobile client device to the apparatus, wherein at least a portion of the front side opposite the holder comprises a substantially transparent material.

2. The apparatus of claim 1, wherein an edge of the front side opposite the top and an edge of the back side opposite the top are substantially rounded.

3. The apparatus of claim 1, wherein the holder is further configured to secure the mobile client device against an inner portion of the front side, wherein the inner portion of the front side is aligned with the at least a portion of the front side opposite the holder.

4. The apparatus of claim 1, wherein the holder comprises a compressible material.

5. The apparatus of claim 4, wherein the compressible material comprises a compressible foam material.

6. The apparatus of claim 1, wherein the substantially transparent material comprises one or more of a perforated material, a diffusive film, or a coated material.

7. The apparatus of claim 6, wherein the coated material comprises a matte coating on an acrylic material.

8. The apparatus of claim 1, further comprising an adjustable weight for adjusting a center of mass of the apparatus.

9. The apparatus of claim 8, wherein the top surface is configured to support the adjustable weight.

10. The apparatus of claim 8, further comprising a shelf coupled to the back side, wherein the shelf is configured to support that adjustable weight.

11. The apparatus of claim 8, further comprising a plurality of protruding surfaces each coupled to the back side, wherein each protruding surface is configured to support the adjustable weight.

12. The apparatus of claim 8, further comprising a track coupled to the apparatus, wherein the adjustable weight is coupled to the track and is configured to adjust along a length of the track.

13. The apparatus of claim 1, further comprising one or more of:
a base supporting the apparatus of claim 1 and operable to rock the apparatus of claim 1 by oscillating; or
a pendulum disposed within the apparatus of claim 1 and operable to rock the apparatus of claim 1 by oscillating.

14. A method of manufacturing an apparatus comprising:
forming a sheet of material, the sheet comprising:
a substantially circular portion;
excess material comprising: (1) at least part of a first protrusion formed at a first edge of the circular portion and (2) at least part of a second protrusion formed at a second edge of the circular portion, wherein the first protrusion and the second protrusion are diametrically opposite each other;
bending the sheet along a first segment and along a second segment, wherein the first and second segment each extend along a portion of the first protrusion and a portion of the second protrusion, and wherein after bending, the sheet comprises at least three sides forming an open enclosure, the at least three sides comprising a back side, a top, and a front side; and
removing, after bending the sheet, the excess material so that each edge of the top is substantially flush with an adjoining edge of the front side and an adjoining edge of the back side.

15. A method comprising:
detecting, by a mobile client device, an orientation of an apparatus holding the mobile client device, wherein the apparatus comprises:
at least three sides forming an open enclosure, the at least three sides comprising a back side, a top, and a front side; and
a holder coupled to the inner surface of the back side and configured to secure the mobile client device to the apparatus, wherein at least a portion of the front side opposite the holder comprises a substantially transparent material; and
determining, based on the detected orientation, content for display on a display of the mobile client device.

16. The method of claim 15, wherein determining, based on the detected orientation, content for display on the display of the mobile client device comprises determining content for display on the display of the mobile client device based on an amount of rotation from an initial orientation.

17. The method of claim 15, further comprising:
detecting a subsequent orientation of the mobile client device; and
determining, based on the detected subsequent orientation of the mobile client device, subsequent content for display on the display of the mobile client device.

18. The method of claim 15, wherein the content comprises a picture selected from a plurality of pictures on the mobile client device.

19. The method of claim 15, wherein the content comprises an effect added to an image displayed on the display.

20. The method of claim 19, wherein at least one of:
an amount of the effect varies based on the detected orientation of the apparatus; or
a type of the effect varies based on the detected orientation of the apparatus.
